(19) United States
(12) Patent Application Publication
(10) Pub. No.: US 2014/0229349 A1
(43) Pub. Date: Aug. 14, 2014

(54) FACILITATING A PERSONAL DATA MARKET

(71) Applicants: Kostadin Dimitrov Yanev, Alamo, CA (US); Ivo Kostadinov Yanev, Sofia (BG)

(72) Inventors: Kostadin Dimitrov Yanev, Alamo, CA (US); Ivo Kostadinov Yanev, Sofia (BG)

(21) Appl. No.: 13/763,430

(22) Filed: Feb. 8, 2013

(51) Int. Cl. G06Q 40/04

(52) U.S. Cl. CPC G06Q 40/04
USPC 705/37

(57) ABSTRACT

This disclosure relates to a system configured to facilitate a personal data market in which personal data is transacted. The system comprises one or more processors configured to execute computer program modules. The system is configured to aggregate personal data from one or more personal data sources and classify the personal data. The personal data comprises a plurality of units associated with one or more people. The system is configured to present the aggregated and classified personal data to users and manage transactions of the personal data. A given transaction comprises a transfer of one or more units of personal data associated with one or more people to a requestor computing platform in exchange for an amount of compensation.

### FIELD

This disclosure relates to facilitating a personal data market in which personal data is transacted.

### BACKGROUND

Various systems for consumer control of personal information exist. Typically, controlling the personal information includes password protecting the information in a specific electronic storage location. The controlled personal information may include financial information, demographic information, and/or heath related information, for example. Controlling the personal information may include manually signing a release form authorizing release of the personal information. For example, heath care providers require signed medical record release forms before releasing medical records for a given patient.

### SUMMARY

One aspect of the disclosure relates to a system configured to facilitate a personal data market in which personal data is transacted, in accordance with one or more implementations. Personal data from one or more users may be valuable. For example, an advertising company may value personal demographic data because advertising may be directed to a specific group of people based on the personal demographic data from the group of people. The system may be configured to facilitate an electronic marketplace where users may buy, sell, trade, and/or otherwise transact personal data for agreed upon compensation. The users may include providers of the personal data, requestors of the personal data, and/or other users. The providers of the personal data may include individuals in possession of personal data associated with themselves, third-party owners of personal data, and/or other users. Requestors of the personal data may include individuals, businesses, and/or other entities that wish to obtain personal data from the providers.

In some implementations, the system may include one or more personal data sources, one or more data collection computing platforms, one or more requestor computing platforms, one or more data market platforms, and/or other components.

The personal data source(s) may include electronic sources of personal data, and/or other sources. The personal data source(s) may include sources of information, hosts of information, external entities participating with the system, and/or other resources. In some implementations, the personal data source(s) may include remote databases. The remote databases may be associated with hospitals, health care providers, wellness centers, gyms, and/or other entities.

The data collection computing platform(s) may be configured to record and/or store information related to activity, physical characteristics, and/or other information associated with a user of a given data collection computing platform. The information related to the activity of the user may include one or more of a fitness metric, a health metric, an exercise metric, a route metric, a nutrition metric, a physical condition metric, and/or other information.

The data collection computing platform(s) may include an interface, one or more sensor(s), and/or other components. The interface may be configured to facilitate manual entry of personal data associated with a user of the given data collection computing platform. The data collection computing platform(s) may include one or more processors configured to execute computer program modules. The computer program modules may be configured to enable a provider associated with a given data collection computing platform to interface with the system, and/or provide other functionality attributed herein to the data collection computing platform(s). In some implementations, the data collection computing platform(s) may include video and/or other three dimensional image capturing devices.

In some implementations, the sensor(s) may be communicatively coupled with the data collection computing platform(s). In some implementations, the sensor(s) may be standalone devices. The sensor(s) may be configured to provide output signals conveying information associated with personal data of a given provider of personal data.

The requestor computing platform(s) may include an interface, one or more processors configured to execute computer program modules, and/or other components. The interface and/or the computer program modules may be configured to enable a given requestor and/or other users associated with a given requestor computing platform to interface with the system, and/or provide other functionality attributed herein to the requestor computing platform(s).

The data market platform(s) may be configured to execute one or more computer program modules. The computer program modules may include one or more of a data aggregation module, a classification module, a share module, a transaction module, a user interface module, and/or other modules.

The data aggregation module may be configured to aggregate personal data from one or more of the personal data source(s). The personal data may comprise a plurality of units associated with one or more people. For example, individual ones of the plurality of units of personal data may include a running route, a medication dosage, a weight, an age, a gender, and/or other units of personal data related to a given person (e.g., a given provider). Individual ones of the plurality of units of personal data may be associated with one or more types of data. The one or more types of data may include exercise data, nutritional data, physical condition data, medication data, medical record data, and/or other data.

Aggregating the personal data may comprise collecting individual ones of the plurality of units of personal data associated with a given person and/or group of people from one or more of the personal data source(s). In some implementations, the data aggregation module may be configured to aggregate data from the data collection computing platform(s).

The classification module may be configured to classify the aggregated personal data based on one or more classifications. The one or more classifications may be established based on classification information received from one or more of the data collection computing platform(s), the requestor computing platform(s), and/or other components of the system. The classification information may include limits on the personal data. In some implementations, the one or more classifications may be associated with one or more of the types of personal data. In some implementations, the classification module may be configured to classify aggregated data associated with a single person.

The share module may be configured to provide an indication of one or more units of personal data and/or one or more classifications of personal data that are available to be transferred in transactions. In some implementations, the availability may be based on availability information received from the data collection computing platform(s). The availability information may include, for example, an authorization to transact personal data from an owner of the personal data, and/or other availability information. In some implementations, the data collection computing platform(s) may receive the availability information from providers of the personal data.

The transaction module may be configured to manage the transactions of personal data. A given transaction may comprise a transfer of one or more units of personal data associated with one or more people to a given requestor computing platform in exchange for an amount of compensation. The transaction module may be configured to receive requests for personal data from the requestor computing platform(s). The transaction module may be configured to determine the amount of compensation based on price information received from the data collection computing platform(s), the requestor computing platform(s), individual ones of the one or more people involved in the given transaction, and/or other sources. In some implementations, the transaction module may be configured to determine the amount of compensation based on a market rate associated with the personal data market. In some implementations, the transaction module may be configured to transfer one or more units of personal data to a given requestor computing platform responsive to receiving payment information from the given requestor computing platform. In some implementations, transaction module 58 may be configured to receive payment and/or payment confirmations from outside payment systems such as PayPal, Money Bookers, and/or other systems.

The user interface module may be configured to provide a graphical user interface for presentation to users. The user interface module may be configured to provide the graphical user interface to users via the data collection computing platform(s), the requestor computing platform(s), and/or other components of the system. In some implementations, the user interface module may be configured to provide a provider graphical user interface to a given provider of the personal data via a given data collection computing platform associated with the provider. A requestor graphical user interface may be provided to a given requestor of personal data via a given requestor computing platform associated with the given requestor. The graphical user interface may be configured to receive user entry and/or selection of information related to the personal data, transactions, and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to facilitate a personal data market in which personal data is transacted, in accordance with one or more implementations.

FIG. 2 illustrates a provider user interface view, in accordance with one or more implementations.

FIG. 3 illustrates a requestor user interface view, in accordance with one or more implementations.

FIG. 4 illustrates a method for facilitating a personal data market in which personal data is transacted, in accordance with one or more implementations.

### DETAILED DESCRIPTION

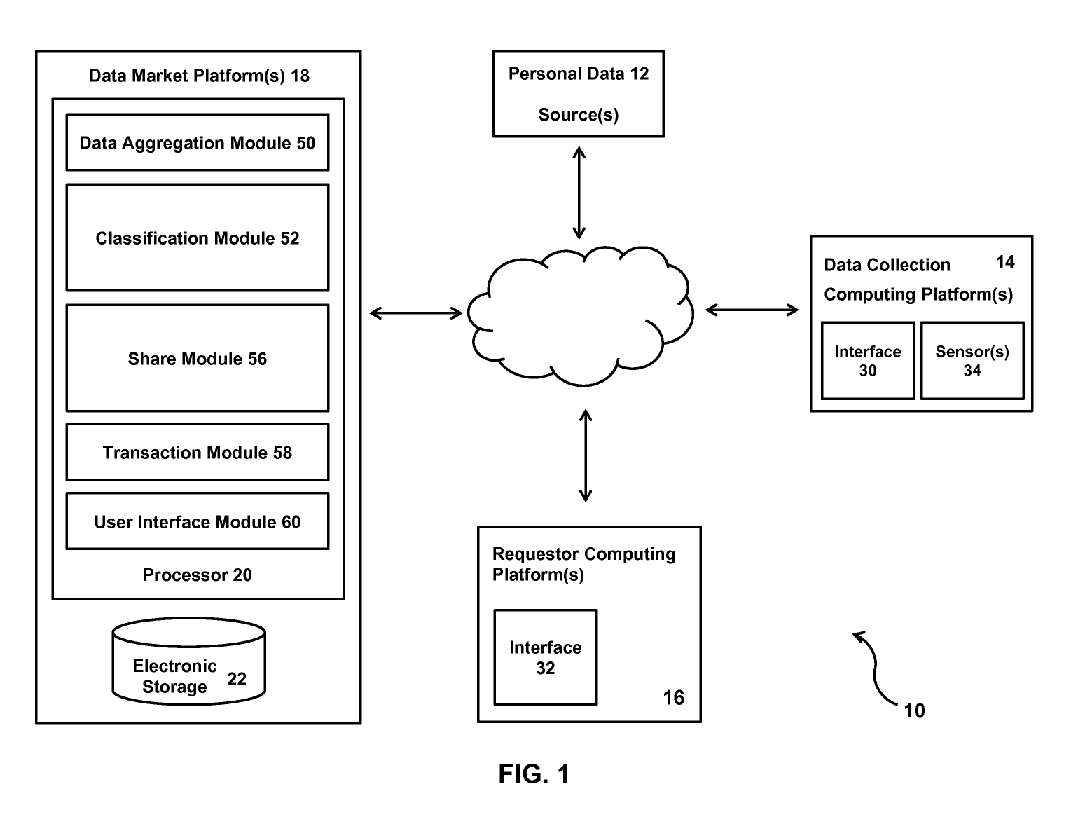

FIG. 1 illustrates a system 10 configured to facilitate a personal data market in which personal data is transacted, in accordance with one or more implementations. Personal data from one or more users may be valuable. For example, an advertising company may value personal demographic data because advertising may be directed to a specific group of people based on the personal demographic data from the group of people. Political campaigns interested in contacting potential voters may value personal contact information. Personal anatomical data may be valuable to medical device companies designing customized medical devices. Research institutions may acquire personal data for their research needs. For example, the research institutions may select people and/or personality types to participate in studies based on the acquired personal data. Other companies who purchase the personal data may use the personal data to select people for “Eco Awards” and/or direct marketing.

System 10 may be configured to facilitate an electronic marketplace where users may buy, sell, trade, and/or otherwise transact personal data for agreed upon compensation. The users may include providers of the personal data, requestors of the personal data, and/or other users. The providers of the personal data may include individuals in possession of personal data associated with themselves, third-party owners of personal data, and/or other users. Requestors of the personal data may include individuals, businesses, and/or other entities that wish to obtain personal data from the providers. It should be appreciated that the personal data market described in the present disclosure may be generalized and applied to transacting any type of data between interested parties.

In some implementations, system 10 may include one or more personal data sources 12, one or more data collection computing platforms 14, one or more requestor computing platforms 16, one or more data market platforms 18, and/or other components. Components of system 10 including personal data source(s) 12, data collection computing platform(s) 14, requestor computing platform(s) 16, data market platform(s) 18, and/or other components of system 10 may be configured to communicate according to a client/server architecture, a peer-to-peer architecture, and/or other architectures. Users may access system 10 via data collection computing platform(s) 14, requestor computing platform(s) 16, and/or other components of system 10.

Personal data source(s) 12 may include electronic sources of personal data, and/or other sources. Personal data source(s) 12 may include sources of information, hosts of information, external entities participating with system 10, and/or other resources. In some implementations, personal data source(s) 12 may include remote databases. The remote databases may be associated with hospitals, health care providers, wellness centers, gyms, activity tracking systems (e.g., Kinect, Leap Motion, Prime Sense), and/or other entities. In some implementations, some or all of the functionality attributed herein to personal data source(s) 12 may be provided by electronic storage 22 of data market platform(s) 18, data collection computing platform(s) 14, and/or other components of system 10. In some implementations, personal data source(s) 12 may include data collection computing platform(s) 14.

Data collection computing platform(s) 14 may be configured to record and/or store information related to activity, physical characteristics, and/or other information associated with a user of a given data collection computing platform 14. The information related to the activity of the user may include one or more of a fitness metric, a health metric, an exercise metric, a route metric, a nutrition metric, a physical condition metric, a daily schedule, and/or other information. For example, the fitness metric may include a resting heart rate, a lung capacity, a lactic acid capacity, and/or other fitness metrics. The health metric may include a blood pressure, a cholesterol level, a body enzyme and/or other body chemical level, allergies, a pill schedule, an amount of sleep, a stress level, and/or other heath metrics. The exercise metric may include exercise type, exercise duration, an exercise rate (e.g., miles per hour), and/or other exercise metrics. The route metric may include a mileage total, a speed, a type of movement, an elevation change, a location, and/or other route metrics. The nutrition metric may include a daily menu, preferred foods, foods avoided because of allergies, a daily calorie count, a food fat content, a food salt content, and/or other nutrition metrics. The physical condition metric may include an amount of weight lifted during a specific exercise, a body fat percentage, a maximum number of push-ups, a one mile run time, and/or other physical condition metrics. The physical characteristics may include size, height, weight, and/or other physical characteristics of the user, and/or of one or more body parts of the user. For example, the physical characteristics may include a waist diameter, an overall height of the user, an overall weight of the user, and/or other physical characteristics.

Data collection computing platform(s) 14 may include an interface 30, one or more sensor(s) 34, and/or other components. In some implementations, data collection computing platform(s) 14 may include video and/or other three dimensional image capturing devices. Interface 30 may be configured to facilitate manual entry of personal data associated with a user of the given data collection computing platform 14. Data collection computing platform(s) 14 may include one or more processors configured to execute computer program modules. The computer program modules may be configured to enable a provider associated with a given data collection computing platform 14 to interface with system 10, and/or provide other functionality attributed herein to data collection computing platform(s) 14. By way of non-limiting example, the given data collection computing platform 14 may include one or more of a desktop computer, a laptop computer, a handheld computer, a tablet computing platform, a NetBook, a Smartphone, a gaming console, an exercise system, and/or other computing platforms.

In some implementations, data collection computing platform(s) 14 may include one or more components of the system described in patent application Ser. No. 13/527,465 filed Jun. 19, 2012, entitled “Personal Wellness Device”; patent application Ser. No. 13/403,803 filed Feb. 23, 2012, entitled “Personal Exercise Device”; and/or patent application Ser. No. 12/818,977 filed Jun. 18, 2010, entitled “Modular Exercise System; all of which are incorporated herein by reference.

In some implementations, sensor(s) 34 may be communicatively coupled with data collection computing platform(s) 14. In some implementations, sensor(s) 34 may be standalone devices. In some implementations, data collection computing platform(s) 14 and sensor(s) 34 may be integrated as a singular device. Sensor(s) 34 may be configured to provide output signals conveying information associated with personal data of a given provider of personal data. In some implementations, sensor(s) 34 may be built into exercise equipment. The exercise equipment may be a data collection computing platform 14. Examples of sensors suitable for inclusion in system 10 as sensor(s) 34 include two dimensional and three dimensional cameras, GPS enabled devices and/or other movement tracking systems, mechanical transducers, rotary transducers, piezoelectric transducers, capacitive transducers, proximity sensors, respiratory sensors, scales, heart rate monitors, pressure sensors, force sensors, accelerometers, radar, and/or other sensors.

Requestor computing platform(s) 16 may include an interface 32, one or more processors configured to execute computer program modules, and/or other components. Interface 32 and/or the computer program modules may be configured to enable a given requestor and/or other users associated with a given requestor computing platform 16 to interface with system 10, and/or provide other functionality attributed herein to requestor computing platform(s) 16. By way of non-limiting example, the given requestor computing platform 16 may include one or more of a desktop computer, a laptop computer, a handheld computer, a tablet computing platform, a NetBook, a Smartphone, a gaming console, and/or other computing platforms.

Data market platform(s) 18 may be configured to execute one or more computer program modules. The computer program modules may include one or more of a data aggregation module 50, a classification module 52, a share module 56, a transaction module 58, a user interface module 60, and/or other modules.

Data aggregation module 50 may be configured to aggregate personal data from one or more personal data source(s) 12. The personal data may comprise a plurality of units associated with one or more people. For example, individual ones of the plurality of units of personal data may include a running route, a medication dosage, a weight, an age, a gender, and/or other units of personal data related to a given person (e.g., a given provider). Individual ones of the plurality of units of personal data may be associated with one or more types and/or sets of data. The one or more types and/or sets of data may include exercise data, nutritional data, physical condition data, medication data, medical record data, personal preference data, personal valuation data, and/or other data. For example, the exercise data may include exercise frequency, an exercise routine, a type of exercise (e.g., biking), and/or other exercise data. The nutrition data may include a meal log, a number of meals per day, a list of consumed foods organized by food group, and/or other nutrition metrics. The physical condition data may include an amount of flexibility, changes in physical condition over time, physical condition goals, and/or other physical condition data. The medication data may include a name of a medication, a dosage, a consumption frequency, and/or other medication data. The medical record data may include x-rays, allergy information, a surgery history, and/or other medical record data. Personal preference data may include preferred trademarks, preferred foods, preferred places, habits, and/or other personal preferences. Personal valuation data may include political bias, completed questionnaires, studies involving the person, and/or other personal opinions. The data described above is not intended to be limiting. The personal data may include any personal information and/or data a person may deem valuable and decide to off for sale via system 10.

Aggregating the personal data may comprise collecting individual ones of the plurality of units of personal data associated with a given person and/or group of people from one or more personal data source(s) 12. In some implementations, data aggregation module 50 may be configured to aggregate data from data collection computing platform(s) 14. For example, aggregation module 50 may be configured to collect running route data and weight data from a given data collection computing platform 14, and medication dosage data, age data, and gender data from a database associated with a health care provider.

Classification module 52 may be configured to classify the aggregated personal data based on one or more classifications. The one or more classifications may be established based on classification information received from one or more data collection computing platform(s) 14, requestor computing platform(s) 16, and/or other components of system 10. The classification information may include limits on the personal data. For example, the classification information may include limits on age such that personal data from people ages 18-39 is grouped into a single classification. In some implementations, classification information may be programmed at manufacture. In some implementations, the one or more classifications may be associated with one or more of the types of personal data. For example, classification module 52 may be configured to group cholesterol level data for females under age 50 into a single classification. As another example, classification module 52 may be configured to group exercise data for people taking heart medication into a single classification. In some implementations, classification module 52 may be configured to group aggregated data associated with a single person into a single classification. In some implementations, classification module 52 may be configured to facilitate a real-time display of the classified personal data via data collection computing platform(s) 14, requestor computing platform(s) 16, and/or other components of system 10.

Share module 56 may be configured to provide an indication of one or more units of personal data and/or one or more classifications of personal data that are available to be transferred in transactions. In some implementations, the availability may be based on availability information received from data collection computing platform(s) 14. The availability information may include, for example, an authorization to transact personal data from an owner of the personal data, and/or other availability information. In some implementations, data collection computing platform(s) 14 may receive the availability information from providers of the personal data. In some implementations, data collection computing platform(s) 14 may receive availability information deeming at least some of the personal data private and unavailable for transaction. In some implementations, data collection computing platform(s) 14 may receive availability information deeming at least some of the personal data available and/or unavailable for transactions with specific requestors. The specific requestors may include individuals and/or businesses, for example. In some implementations, data collection computing platform(s) 14 may receive availability information deeming specific classifications of personal data available and/or unavailable for transfer. In some implementations, share module 56 may be configured to indicate whether individual ones of the units of personal data are available to be transferred on a unit by unit basis based on the availability information. For example, the age and gender of a given provider may be available while an address and phone number of the provider may not be available.

Transaction module 58 may be configured to manage the transactions of personal data. A given transaction may comprise a transfer of one or more units of personal data associated with one or more people to a given requestor computing platform 16 in exchange for an amount of compensation. Transfer to the given requestor computing platform 16 may comprise remotely transmitting the information over a wired and/or wireless network, downloading information directly from data market platform(s) 18, saving a copy to a memory device for manual transmission, and/or other modes of transfer. The one or more people may include providers of the personal data and/or other people. Transaction module 58 may be configured to receive requests for personal data from requestor computing platform(s) 16. Transaction module 58 may be configured to determine the amount of compensation based on price information received from data collection computing platform(s) 14, requestor computing platform(s) 16, individual ones of the one or more people involved in the given transaction, and/or other sources. For example, a given data collection computing platform may receive entry of an asking price of $100 for 100 phone numbers from a given provider. The amount of compensation may include an amount of real currency, an amount of virtual currency, a trade for real goods, a trade for virtual goods, a trade for information, and/or other compensation. Virtual currency and/or virtual goods may include an “inventory” of virtual assets that a user may use within a virtual space. The user may use the virtual currency and/or virtual goods by manipulation of a user character and/or other user controlled elements within the virtual space. For example, an asking price may include a specific power related to a character in a videogame.

In some implementations, transaction module 58 may be configured to determine the amount of compensation based on a market rate associated with the personal data market. In some implementations, transaction module 58 may be configured to determine the market rate based on an analysis of the personal data market. The analysis of the personal data market may be based on previous transactions in the personal data market, price information set by requestors associated with current personal data requests, price information set by providers associated with personal data that is available for transactions, and/or other information. For example, a previous transaction in the personal data market may include a price paid for personal data that is similar to currently available personal data. Transaction module 58 may be configured to determine that the price for the currently available personal data is the same as the price paid in the previous transaction. In some implementations, transaction module 58 may be configured to determine the amount of compensation based on other methods accepted by the parties involved in a given transaction.

In some implementations, transaction module 58 may be configured to transfer one or more units of personal data to a given requestor computing platform 16 responsive to receiving payment information from the given requestor computing platform 16. In some implementations, transaction module 58 may be configured to match available personal data at provider specified compensation levels with corresponding personal data requests having offered compensation levels that meet and/or exceed the provider specified compensation levels. Transaction module 58 may be configured to transfer one or more units of personal data to the given requestor computing platform 16 responsive to a match. In some implementations, transaction module 58 may be configured to receive payment and/or payment confirmations from outside payment systems such as PayPal, Money Bookers, and/or other systems.

In some implementations, transaction module 58 may be configured to transfer at least a portion of the amount of compensation transferred during the transactions to a provider of system 10. The portion of the amount of compensation may be remuneration for, and/or a commission from, the transactions. For example, the provider of system 10 may include an owner of system 10 and/or other providers. The portion of the amount of compensation may be a percentage of the compensation and/or other portions. For a given transaction, the amount of compensation may be $100. The owners of system 10 may receive a 10% commission, or $10, for the given transaction. In some implementations, the portion of the amount of compensation transferred to the provider of system 10 may be automatically set by transaction module 58. In some implementations, the portion of the amount of compensation transferred to the provider of system 10 may be agreed upon by the provider of system 10 and the provider of the personal information.

User interface module 60 may be configured to provide a graphical user interface for presentation to users. User interface module 60 may be configured to provide the graphical user interface to users via data collection computing platform(s) 14, requestor computing platform(s) 16, and/or other components of system 10. In some implementations, user interface module 60 may be configured to provide a provider graphical user interface to a given provider of the personal data via a given data collection computing platform 14 associated with the provider. A requestor graphical user interface may be provided to a given requestor of personal data via a given requestor computing platform 16 associated with the given requestor. The graphical user interface may be configured to receive user entry and/or selection of information related to the personal data, transactions, and/or other information. For example, the graphical user interface may receive entry and/or selections of classifications of personal data that are available to be transferred from the given provider.

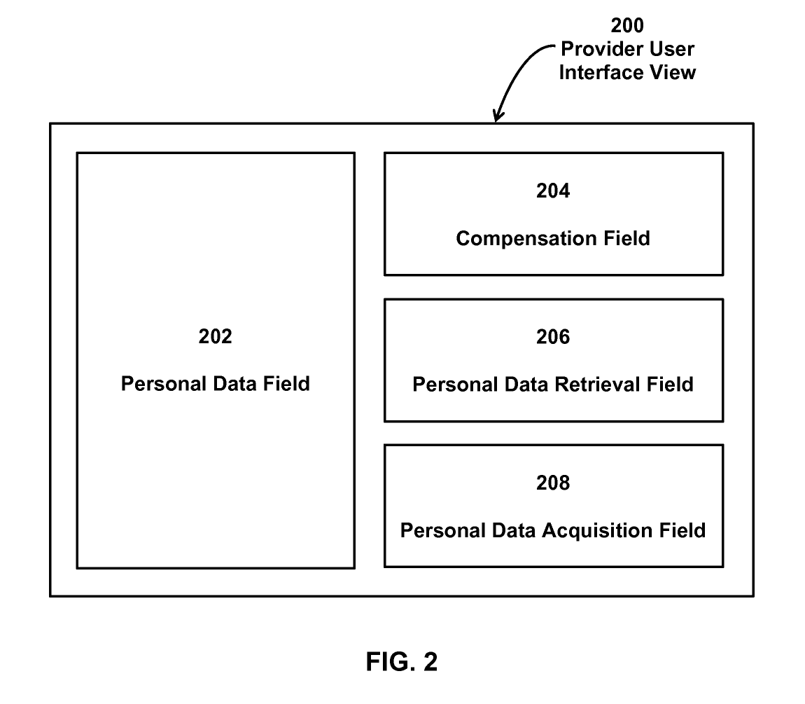

By way of a non-limiting example, FIG. 2 illustrates a provider user interface view 200, in accordance with one or more implementations. Provider user interface view 200 may be presented via data collection computing platform(s) 14 (shown in FIG. 1), and/or other components of system 10. As depicted in FIG. 2, provider user interface view 200 may include one or more of a personal data field 202, a compensation field 204, a personal data retrieval field 206, a personal data acquisition field 208, and/or other fields and/or information. Fields 202, 204, 206, 208, and/or other fields may include graphics, text, and/or other descriptive information. The depiction of provider user interface view 200 is not intended to be limiting as one or more of fields 202, 204, 206, and/or 208 may be omitted or combined with another field.

Personal data field 202 may be configured to receive entry and/or selection of information related to the personal data. Information related to the personal data may include contact information of the provider of the personal data, a textual and/or graphical description of the personal data, personal data classifications, whether the personal data is available for transfer to any requestor and/or a subset of requestors, and/or other information. Personal data field 202 may be provided by, or in conjunction with, a user interface module, a data aggregation module, a classification module, and/or a share module that are the same as or similar to user interface module 60, data aggregation module 50, classification module 52, and/or share module 56, in accordance with one or more implementations.

Compensation field 204 may be configured to receive entry and/or selection of information related to a desired amount of compensation for the available personal data. The desired amount of compensation may be received for one or more individual ones of the plurality of units of personal data, one or more of the classifications of personal data, and/or other personal data. Compensation field 204 may be provided by, or in conjunction with, a user interface module and/or a transaction module that are the same as or similar to user interface module 60 and/or transaction module 58, in accordance with one or more implementations.

Personal data retrieval field 206 may be configured to facilitate retrieval of personal data from a database, electronic storage integrated in data collection computing platform(s) 14, a removable storage location, and/or other locations. For example, field 206 may be configured to facilitate an upload of personal data from a given data collection computing platform 14 associated with a given provider of the personal data. Personal data retrieval field 206 may be provided by, or in conjunction with, a user interface module and/or an aggregation module that are the same as or similar to user interface module 60 and/or aggregation module 50, in accordance with one or more implementations.

Personal data acquisition field 208 may be configured to facilitate acquisition of personal data via data collection computing platform(s) 14, and/or other data collection devices. For example, the given data collection computing platform may include a sensor. Field 208 may facilitate gathering information related to current exercise data conveyed by output signals from the sensor. Personal data acquisition field 208 may be provided by, or in conjunction with, a user interface module and/or an aggregation module that are the same as or similar to user interface module 60 and/or aggregation module 50, in accordance with one or more implementations.

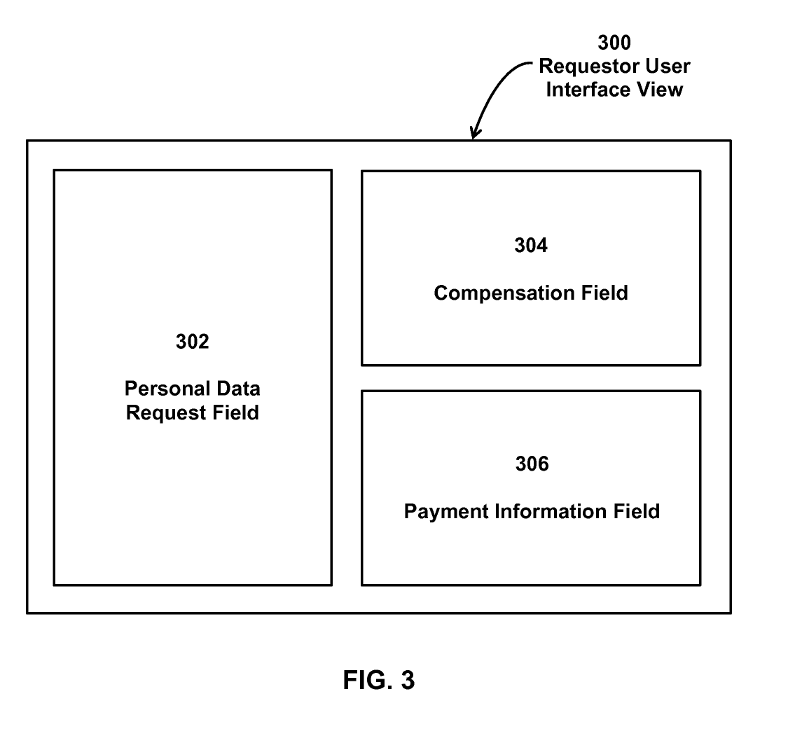

By way of a second non-limiting example, FIG. 3 illustrates a requestor user interface view 300, in accordance with one or more implementations. Requestor user interface view 300 may be presented via requestor computing platform(s) 16 (shown in FIG. 1), and/or other components of system 10. As depicted in FIG. 3, requestor user interface view 300 may include one or more of a personal data request field 302, a compensation field 304, a payment information field 306, and/or other fields and/or information. Fields 302, 304, 306, and/or other fields may include graphics, text, and/or other descriptive information. The depiction of requestor user interface view 300 is not intended to be limiting as one or more of fields 302, 304, and/or 306 may be omitted or combined with another field.

Personal data request field 302 may be configured to receive entry and/or selection of information related to the personal data desired by a given requestor for a transaction. Information related to the personal data may include, for example, contact information of the provider of the personal data, a textual and/or graphical description of the data, classifications of the personal data, and/or other information. Personal data request field 302 may be provided by, or in conjunction with, a user interface module and/or a transaction module that are the same as or similar to user interface module 60 and/or transaction module 58, in accordance with one or more implementations.

Compensation field 304 may be configured to receive entry and/or selection of information related to an offered amount of compensation for the desired personal data. Information related to an offered amount of compensation may include an offered price of real currency (e.g., $100). The offered amount of compensation may be set for one or more individual ones of the plurality of units of personal data, one or more of the classifications of personal data, and/or other personal data. Compensation field 304 may be provided by, or in conjunction with, a user interface module and/or a transaction module that are the same as or similar to user interface module 60 and/or transaction module 58, in accordance with one or more implementations.

Payment information field 306 may be configured to receive entry and/or selection of payment related information. Payment related information may include, for example, credit card information, bank routing number information, online payment (e.g., PayPal) information, and/or other payment related information. In some implementations, payment related information may include requestor contact information. For example, when the compensation for a transaction is a trade for real goods, the requestor and/or provider contact information may be used to complete the trade. Payment information field 306 may be provided by, or in conjunction with, a user interface module and/or a transaction module that are the same as or similar to user interface module 60 and/or transaction module 58, in accordance with one or more implementations.

Returning to FIG. 1, personal data source(s) 12, data collection computing platform(s) 14, requestor computing platform(s) 16, data market platform(s) 18, and/or other components of system 10 may be operatively linked via one or more electronic communication links. For example, such electronic communication links may be established, at least in part, via a network such as the Internet and/or other networks. In some implementations, personal data source(s) 12, data collection computing platform(s) 14, and/or requestor computing platform(s) 16 may be configured to communicate directly with data market platform(s) 18. It will be appreciated that this is not intended to be limiting, and that the scope of this disclosure includes implementations in which personal data source(s) 12, data collection computing platform(s) 14, requestor computing platform(s) 16, and/or other components of system 10 may be operatively linked via some other communication media, or with linkages not shown in FIG. 1.

As shown in FIG. 1, data collection computing platform(s) 14 may be configured to provide an interface 30 between data collection computing platform(s) 14 and users through which users may provide information to and receive information from system 10. Requestor computing platform(s) 16 may be configured to provide an interface 32 between requestor computing platform(s) 16 and users through which users may provide information to and receive information from system 10. In some implementations, interfaces 30 and/or 32 may be configured to display the graphical user interface. This enables data, cues, results, and/or instructions and any other communicable items, collectively referred to as “information,” to be communicated between the user and system 10. For example, “information” may include the personal data, the classifications of personal data, the personal data available to be transferred in a given transaction, a price for a unit of personal data, and/or other information. Examples of interface devices suitable for inclusion in interfaces 30 and/or 32 include a touch screen, a keypad, buttons, switches, a keyboard, knobs, levers, a display, speakers, a microphone, an indicator light, an audible alarm, a printer, and/or other interface devices. In some implementations, interfaces 30 and/or 32 may include a plurality of separate interfaces. In some implementations, interface 30 includes at least one interface that is provided integrally with data collection computing platform(s) 14. In some implementations, interface 32 includes at least one interface that is provided integrally with requestor computing platform(s) 16.

It is to be understood that other communication techniques, either hard-wired or wireless, are also contemplated by the present disclosure as interfaces 30 and/or 32. For example, the present disclosure contemplates that interfaces 30 and/or 32 may be integrated with a removable storage interface provided by data collection computing platform(s) 14 and/or requestor computing platform(s) 16. In this example, information may be loaded into data collection computing platform(s) 14 and/or requestor computing platform(s) 16 from removable storage (e.g., a smart card, a flash drive, a removable disk) that enables the user to customize the implementation of data collection computing platform(s) 14 and/or requestor computing platform(s) 16. Other exemplary input devices and techniques adapted for use with data collection computing platform(s) 14 and/or requestor computing platform(s) 16 as user interfaces 30 and/or 32 include, but are not limited to, an RS-232 port, RF link, an IR link, modem (telephone, cable or other). In short, any technique for communicating information with data collection computing platform(s) 14 and/or requestor computing platform(s) 16 is contemplated by the present disclosure as interfaces 30 and/or 32.

Data market platform(s) 18 may include electronic storage 22, one or more processors 20, and/or other components. Data market platform(s) 18 may include one or more servers, and/or one or more communication lines, or ports to enable the exchange of information with a network and/or other computing platforms such as personal data source(s) 12, data collection computing platform(s) 14, and/or requestor computing platform(s) 16. In some implementations, data market platform(s) 18 may be one or more servers. Illustration of data market platform(s) 18 in FIG. 1 is not intended to be limiting. Data market platform(s) 18 may include a plurality of hardware, software, and/or firmware components operating together to provide the functionality attributed herein to data market platform(s) 18. For example, data market platform(s) 18 may be implemented by a cloud of computing platforms operating together as data market platform(s) 18.

Electronic storage 22 may include electronic storage media that electronically stores information. The electronic storage media of electronic storage 22 may include one or both of system storage that is provided integrally (i.e., substantially non-removable) with data market platform(s) 18 and/or removable storage that is removably connectable to data market platform(s) 18 via, for example, a port (e.g., a USB port, a firewire port) or a drive (e.g., a disk drive). Electronic storage 22 may include one or more of optically readable storage media (e.g., optical disks), magnetically readable storage media (e.g., magnetic tape, magnetic hard drive, floppy drive), electrical charge-based storage media (e.g., EEPROM, RAM), solid-state storage media (e.g., flash drive), and/or other electronically readable storage media. Electronic storage 22 may include one or more virtual storage resources (e.g., cloud storage, a virtual private network, and/or other virtual storage resources). Electronic storage 22 may store software algorithms, information determined by processor(s) 20, information received from personal data source(s) 12, information received from data collection computing platform(s) 14, information received from requestor computing platform(s) 16, and/or other information that enables data market platform(s) 18 to function as described herein. By way of a non-limiting example, aggregated and/or classified personal data may be stored in electronic storage 22. Electronic storage 22 may be configured to store information such that the information may be accessed by data market platform(s) 18, data collection computing platform(s) 14, requestor computing platform(s) 16, and/or other components of system 10. Electronic storage 22 may be configured to store the information for later transfer to a given requestor computing platform 16 during a given transaction.

Processor(s) 20 may be configured to provide information processing capabilities in data market platform(s) 18. As such, processor(s) 20 may include one or more of a digital processor, an analog processor, a digital circuit designed to process information, an analog circuit designed to process information, a state machine, and/or other mechanisms for electronically processing information. Although processor(s) 20 are shown in FIG. 1 as a single entity, this is for illustrative purposes only. In some implementations, processor(s) 20 may include a plurality of processing units. These processing units may be physically located within the same device, or processor(s) 20 may represent processing functionality of a plurality of devices operating in coordination. Processor(s) 20 may be configured to execute modules 50, 52, 56, 58, 60, and/or other modules. Processor(s) 20 may be configured to execute modules 50, 52, 56, 58, 60, and/or other modules by software; hardware; firmware; some combination of software, hardware, and/or firmware; and/or other mechanisms for configuring processing capabilities on processor(s) 20.

It should be appreciated that although modules 50, 52, 56, 58, and 60 are illustrated in FIG. 1 as being co-located within a single processing unit, in implementations in which processor(s) 20 include multiple processing units, one or more of modules 50, 52, 56, 58, and/or 60 may be located remotely from the other modules. The description of the functionality provided by the different modules 50, 52, 56, 58, and/or 60 described herein is for illustrative purposes, and is not intended to be limiting, as any of modules 50, 52, 56, 58, 60, and/or other modules may provide more or less functionality than is described. For example, one or more of modules 50, 52, 56, 58, 60, and/or other modules may be eliminated, and some or all of its functionality may be provided by other ones of modules 50, 52, 56, 58, 60, and/or other modules. As another example, processor(s) 20 may be configured to execute one or more additional modules that may perform some or all of the functionality attributed to one of modules 50, 52, 56, 58, and/or 60.

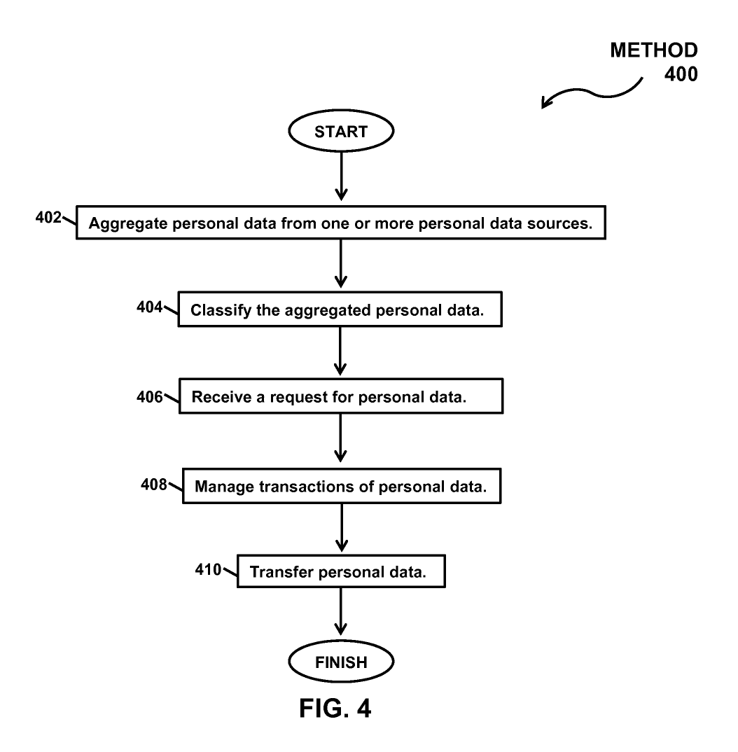

FIG. 4 illustrates a computer implemented method 400 for facilitating a personal data market in which personal data is transacted, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At an operation 402, personal data from one or more personal data sources may be aggregated. The personal data may comprise a plurality of units associated with one or more people. The one or more personal data sources may include a data collection computing platform configured to record and store information related to activity of a user of the data collection computing platform. In some implementations, operation 402 may be performed by a computer program module similar to and/or the same as data aggregation module 50 (shown in FIG. 1, and described herein).

At an operation 404, the aggregated personal data may be classified. The aggregated personal data may be classified based on one or more classifications. Individual ones of the one or more classifications may be established based on classification information received from one or more of the data collection computing platform, a requestor computing platform, and/or other computing platforms. Individual ones of the classifications may be associated with a type of personal data. In some implementations, operation 404 may be performed by a computer program module similar to and/or the same as classification module 52 (shown in FIG. 1, and described herein).

At an operation 406, requests for personal data may be received. The requests for personal data may be received from a requestor computing platform associated with a given requestor. In some implementations, operation 406 may be performed by a computer program module similar to and/or the same as transaction module 58 (shown in FIG. 1, and described herein).

At an operation 408, transactions of personal data may be managed. A given transaction may comprise a transfer of one or more units of personal data associated with one or more people to the requestor computing platform in exchange for an amount of compensation. The amount of compensation may be determined based on price information received from one or more of the data collection computing platform, the requestor computing platform, individual ones of the one or more people involved in the given transaction, the requestor, or a market rate associated with the personal data market. In some implementations, one or more classifications of personal data that are available to be transferred in the given transaction may be indicated such that only the classifications of personal data that are available may be transacted. In some implementations, operation 408 may be performed by a computer program module similar to and/or the same as transaction module 58 (shown in FIG. 1, and described herein).

At an operation 410, personal data may be transferred. The personal data may be transferred to the requestor computing platform associated with the given requestor. Transfer to the requestor computing platform may comprise remotely transmitting the information over a wired and/or wireless network, downloading information directly from a data market platform, saving a copy to a memory device for manual transmission, and/or other modes of transfer. The personal data may be transferred responsive to receiving payment information from the given requestor computing platform. In some implementations, operation 410 may be performed by a computer program module similar to and/or the same as transaction module 58 (shown in FIG. 1, and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured to facilitate a personal data market in which personal health data is transacted, the system comprising:
one or more processors configured to execute computer program modules, the computer program modules comprising:
a data aggregation module configured to aggregate personal data from one or more personal data sources, the personal data comprising a plurality of units associated with one or more people, individual ones of the plurality of units of personal data including a given person's medical data that requires authorized release by the given person; and
a transaction module configured to manage transactions of personal data, a given transaction comprising a transfer of one or more units of personal data associated with one or more people to a requestor computing platform in exchange for an amount of compensation.

2. The system of claim 1, wherein individual ones of the plurality of units of personal data are associated with one or more of exercise data, nutritional data, physical condition data, medication data, medical record data, personal preference data, or personal valuation data.

3. The system of claim 1, wherein the one or more personal data sources include a remote database.

4. The system of claim 1, wherein the one or more personal data sources include a data collection computing platform configured to record and store information related to activity of a user of the data collection computing platform.

5. The system of claim 4, wherein the information related to the activity of the user includes one or more of a fitness metric, a health metric, an exercise metric, a route metric, a nutrition metric, a physical condition metric, or a daily schedule.

6. The system of claim 1, wherein the computer program modules further comprise a classification module configured to classify the aggregated personal data based on one or more classifications.

7. The system of claim 6, wherein individual ones of the one or more classifications are established based on classification information received from one or more of a data collection computing platform or the requestor computing platform.

8. The system of claim 6, wherein individual ones of the classifications are associated with a type of personal data.

9. The system of claim 1, wherein the computer program modules further comprise a share module configured to provide an indication of (1) one or more units of personal data or (2) one or more classifications of personal data that are available to be transferred in the given transaction.

10. The system of claim 9, wherein the availability is based on availability information received from a data collection computing platform.

11. The system of claim 1, further comprising a user interface module configured to provide a graphical user interface for presentation to a user, the graphical user interface being configured to receive user selections of information related to one or more of the personal data, individual ones of the plurality of units of personal data, one or more classifications of personal data that are available to be transferred in the given transaction, or the given transaction.

12. The system of claim 1, wherein the transaction module is further configured to receive requests for personal data from the requestor computing platform.

13. The system of claim 1, wherein the amount of compensation is determined based on price information received from one or more of a data collection computing platform, the requestor computing platform, individual ones of the one or more people involved in the given transaction, the requestor, or a market rate associated with the personal data market.

14. The system of claim 1, wherein the transaction module is further configured to determine the amount of compensation based on an analysis of the personal data market, the analysis of the personal data market being based on previous transactions in the personal data market.

15. The system of claim 1, wherein the amount of compensation includes one or more of an amount of real currency, an amount of virtual currency, a trade for real goods, a trade for virtual goods, or a trade for information.

16. The system of claim 1, wherein the transaction module is configured to transfer at least a portion of the amount of compensation transferred during the given transaction to a provider of the system.

17. A computer implemented method for facilitating a personal data market in which personal health data is transacted, the method being performed by one or more processors configured to execute computer program modules, the method comprising:
using one or more processors to aggregate personal data from one or more personal data sources, the personal data comprising a plurality of units associated with one or more people; and
using one or more processors to manage transactions of personal data, a given transaction comprising a transfer of one or more units of personal data associated with one or more people to a requestor computing platform in exchange for an amount of compensation.

18. The method of claim 17, wherein the one or more personal data sources include a data collection computing platform configured to record and store information related to a user of the data collection computing platform.

19. The method of claim 17, further comprising using one or more processors to classify the aggregated personal data based on one or more classifications.

20. The method of claim 17, further comprising using one or more processors to provide an indication of (1) one or more units of personal data or (2) one or more classifications of personal data that are available to be transferred in the given transaction.

21. The method of claim 17, wherein the amount of compensation is determined based on price information received from one or more of a data collection computing platform, the requestor computing platform, individual ones of the one or more people involved in the given transaction, the requestor, or a market rate associated with the personal data market.
